(19) United States
(12) Patent Application Publication
(10) Pub. No.: US 2007/0035516 A1
(43) Pub. Date: Feb. 15, 2007

(54) Joystick sensor with light detection

(75) Inventors: Andrew M. Voto, Brighton, MI (US); Ronald K. Selby, Flint, MI (US); Kenneth D. Perry, New Lothrop, MI (US); David A. Ross, Columbiaville, MI (US); Alfred V. Dumsa JR., Hartland, MI (US); Ray Lippmann, Howell, MI (US); Yansong Chen, Kokomo, IN (US)

Correspondence Address: DELPHI TECHNOLOGIES, INC., M/C 480-410-202, PO BOX 5052, TROY, MI, 48007, US

(73) Assignee: Delphi Technologies, Inc., Troy, MI (US)

(21) Appl. No.: 11/199,630

(22) Filed: Aug. 9, 2005

(51) Int. Cl. G09G 5/08

(52) U.S. Cl. 345/161

(57) ABSTRACT

The present invention creates a virtual sensor plane by arraying two one-dimensional light sensors at right angles to one another wherein the shaft of a joystick extends perpendicularly through the virtual sensor plane. With this configuration, the sensor plane can detect traditional joystick rotation around a point along its axis as well as a herein-disclosed true rotation of the joystick around the joystick axis itself. Between the light sources and lenses which enable light detection and the optical, rather than mechanical or electromechanical, nature of the light sensors, wear surfaces in the joystick are minimized or eliminated everywhere except, where applicable, in the universal joint at the base of joystick configurations which include such a universal joint.

### BACKGROUND OF THE INVENTION

1. Field of the Invention

This invention relates to manual controls of the joystick type useful in the operation of motorized wheelchairs. The manual controls can have application in other technologies as well, including but not limited to vehicles besides wheelchairs, video games and training simulators.

2. Description of Related Art

Motorized wheelchairs are becoming more and more common, and typically they are guided by what are referred to as “joystick” controls. Ordinarily, a graspable handle is pivotally mounted for universal rotation around a point along its axis and sensors are provided to identify the angle of tilt along the perpendicular axes through the point of rotation. Numerous sensing schemes have been used, such as potentiometers in contact with brushes that move corresponding to the tilt of the joystick (see U.S. Pat. No. 4,856,785 and No. 6,259,433). Some joystick sensors harness the interaction of induction coils, such as are disclosed in U.S. Pat. No. 4,879,556 and No. 5,911,627. “Hall Effect” and other magnetic sensors have been used for sensing the tilt as well, such as are disclosed in U.S. Pat. Nos. 5,160,918, 5,831,554 and 5,831, 596. Inductive based sensors, which move a copper plate above a plane of coils, are disclosed in U.S. Pat. No. 6,445,311. Resistive based sensors are also known, in which a resistive wiper arm moves for each axis of the joystick.

Virtually all if not all of the existing joysticks are replete with disadvantages inherent in their mechanical and electromagnetic designs. Magnetic sensors require movement of magnets in a relatively complex manner and are vulnerable to interference from outside magnetic fields. Resistive sensors require movement of the wiper along a resistive surface, with inevitable unwanted wear at the contact surfaces. Multiple parts make for large devices and undesirably high costs including the labor required for assembly.

Accordingly, a need remains for joystick controls, for wheelchairs and other applications, in which size, moving parts and assembly labor requirements are minimized and non-wearing features, such as optics implementations, are maximized.

### SUMMARY OF THE INVENTION

In order to meet this need, the present invention provides a specialized system of light detection of the relative motion of the shaft of a joystick, including traditional joystick angularized rotation around a point along its axis as well as true axial rotation of the joystick in its vertical position. Among the light sources and lenses which enable the light detection and the optical nature of the light sensors, wear surfaces in the joystick are minimized or eliminated everywhere except, where applicable, in the universal joint at the base of certain joystick designs. The specialized system includes two one-dimensional light sensors, such as without limitation CCD or CMOS or other sensors, mounted at right angles to one another, which together define the x and y axis of a virtual sensor plane through which the joystick shaft extends perpendicularly. Regardless of the joystick's location, the joystick registers both an “x” and a “y” location on each one-dimensional light sensor, respectively, which location signal and the subsequent change in location signal creates a guidance vector. Additionally, the two one-dimensional sensor arrays can register whether the shaft of the joystick has rotated about its own axis, as long as the joystick shaft is optically variegated at the portion of the joystick shaft which intersects the sensor plane so that the extent and direction of rotation of the shaft can be optically discerned. The above combined sensing options make it possible to create true forward/back, side-to-side and rotational vectors via a joystick. In wheelchair applications, the separate forward/back, side-to-side and rotational vectors can translate into improved occupant mobility, especially when all four wheels of the wheelchair can be guided according to the joystick vectors.

### BRIEF DESCRIPTION OF THE DRAWING(S)

FIG. 1 is a side sectional view of the joystick of the present invention.

FIG. 2 is a sectional view of the present joystick along lines II-II of FIG. 1.

FIGS. 3a and 3b are partial side schematic view of the joystick which show the ability of the light sensors 24 to detect the rotational movement of a stripe 28 on the elongate shaft 20 of the joystick.

FIGS. 4-6 are schematic diagrams of a simplified array in which light sensors are positioned adjacent appropriate lenses and opposite the joystick shaft from light emitting diode (LED) light sources.

FIG. 7 represents an overlay combination of FIGS. 5 and 6 in which light intensity data “L” and “D” are shown, representing “bright” and “dark” respectively.

FIG. 8 is a schematic diagram of an alternate embodiment of the invention in which the light source and the light sensor are positioned in close proximity.

FIG. 9 is a schematic diagram of three exemplary joystick positions and the corresponding wheel positions of the wheelchair thus controlled.

### DESCRIPTION OF THE PREFERRED EMBODIMENT(S)

The present invention creates a virtual sensor plane by arraying two one-dimensional light sensors at right angles to one another wherein the shaft of a joystick extends perpendicularly through the virtual sensor plane. With this configuration, the sensor plane can detect traditional joystick rotation around a point along its axis as well as a herein-disclosed true rotation of the joystick around the joystick axis itself. Between the light sources and lenses which enable light detection and the optical, rather than mechanical or electromechanical, nature of the light sensors, wear surfaces in the joystick are minimized or eliminated everywhere except, where applicable, in the universal joint at the base of joystick configurations which include such a universal joint. The light sensors may be CCD sensors or CMOS sensors, as nonlimiting examples. Regardless of the joystick's location, the joystick registers both an “x” and a “y” location on each one-dimensional light sensor, respectively, which in turn registers the location of the joystick in the above-mentioned sensor plane. Additionally, the two one-dimensional sensor arrays can register whether the shaft of the joystick has rotated about its own axis, as long as the joystick shaft is optically variegated in some way at the portion of the joystick shaft that intersects the sensor plane so that the extent and direction of rotation of the shaft can be registered by the CCD sensors. The above sensor plane makes it possible to detect not only forward/backward and left/right motion of the joystick, but also actual rotation of the joystick, with concomitant ability of the joystick to guide the chair not only straight forward and in direct reverse, but also straight left and straight right, with actual rotation of the chair being controlled by true axial rotation of the joystick shaft.

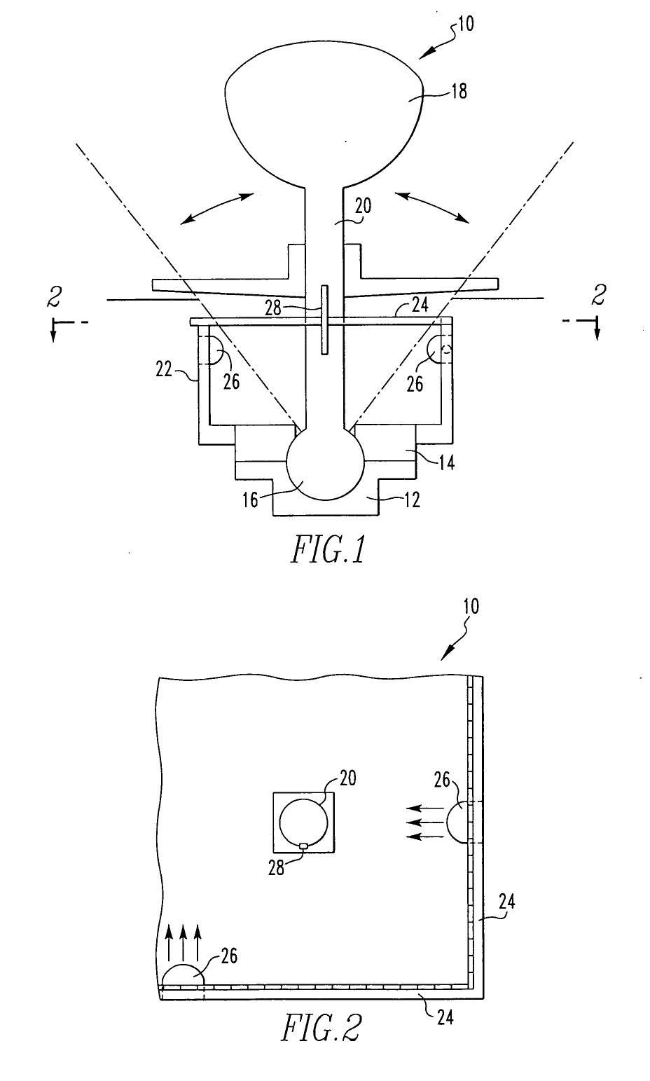

Formally, the joystick is acknowledged to be a manually-operated control for generating a vector signal. Referring now to FIG. 1, the preferred embodiment of the present manually-operated control 10 comprises a housing including a lower housing 12 and an upper housing 14 defining a socket for a universal joint having a ball 16 therein. A handle 18 with an elongate shaft 20 having an axis is pivotally mounted within the socket of the housing for universal rotation about a pivot point on the axis of the ball 16. The elongate shaft is likewise able to rotate in either direction around the true axis of the shaft. The housing has provided thereto upon two vertical supports 22 two one-dimensional light sensors 24, positioned at right angles to one another and creating a “sensor plane” through which the elongate shaft 20 extends perpendicularly. One and preferably two (or more) light sources 26 are used to illuminate the shaft. The light sources may be but need not be LEDs. The lights 26 may be shone in the direction of the elongate shaft from the same general position as occupied by the two rectilinearly disposed light sensors 24. Alternatively, the light sources may be mounted at any other point on the perimeter of the virtual plane created by the light sensors 24 as long as the light is directed in the general area of the elongate shaft 20 to illuminate it. The stripe 28 provides an optical variant which allows differential sensing of the axial vertical rotation of the elongate shaft 20 by the light sensors 24. In FIG. 1, the stripe 28 is a thickly painted, somewhat protruding stripe of a material of a different color than the elongate shaft 20, but any other optical variant could be substituted including but not limited to notches or other texture or marking patterns extending along the elongate shaft 20 on at least the portion of the elongate shaft 20 which intersects the plane formed by the rectangularly disposed light sensors 24.

Referring now to FIG. 2, which is a sectional view along lines II-II of FIG. 1, the manually-operated control 10 includes a joystick handle having an elongate shaft 20 centrally disposed centrally to two one-dimensional light sensors 24 positioned adjacent to and at right angles to one another. The light sources 26 shine light in the direction of the elongate shaft 20 to illuminate it and in turn to create reflections from the elongate shaft 20 which can be received by the light sensors 24. The stripe 28 may be of any optically varied material which creates a different reflection on the light sensors 24 so that the light sensors 24 can discern vertical rotation of the elongate shaft 20.

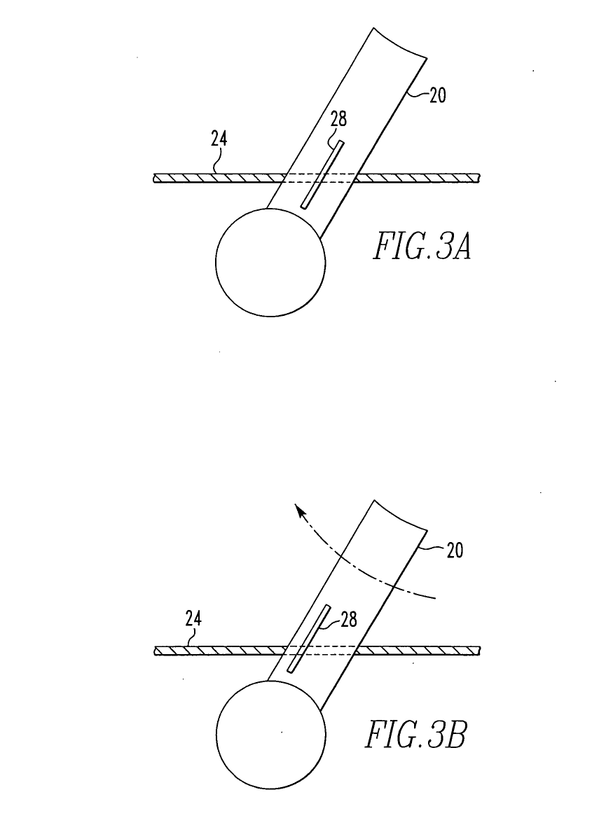

FIG. 3 is a partial side schematic view of the joystick handle and elongate shaft 20 of FIGS. 1 and 2 shown adjacent an illustrative light sensor 24. In the embodiment of FIG. 3, it is not only possible for the light sensor 24 to detect rotation of the elongate shaft 20 when it is in a true vertical position, as depicted in FIGS. 1 and 2, but the relative motion of the stripe 28 can also be discerned when the elongate shaft 20 is off-vertical as well. In FIG. 3a, the stripe 28 on the elongate shaft 20 is in an original, unrotated position. In FIG. 31, the elongate shaft 20 has already undergone clockwise rotation and the movement of the stripe 28 can be received by the light sensor 24 accordingly.

It should be borne in mind that, inside the housing of a joystick, there is little or no ambient light. This means that virtually any lighting scheme may be used to illuminate the elongate shaft 20 and to reflect onto the light sensors 24. Lighting schemes may include, without limitation, the use of visible, infrared, ultraviolet or other lights of varying wavelengths as long as the light is compatible with the light sensing capabilities of the light sensors 24.

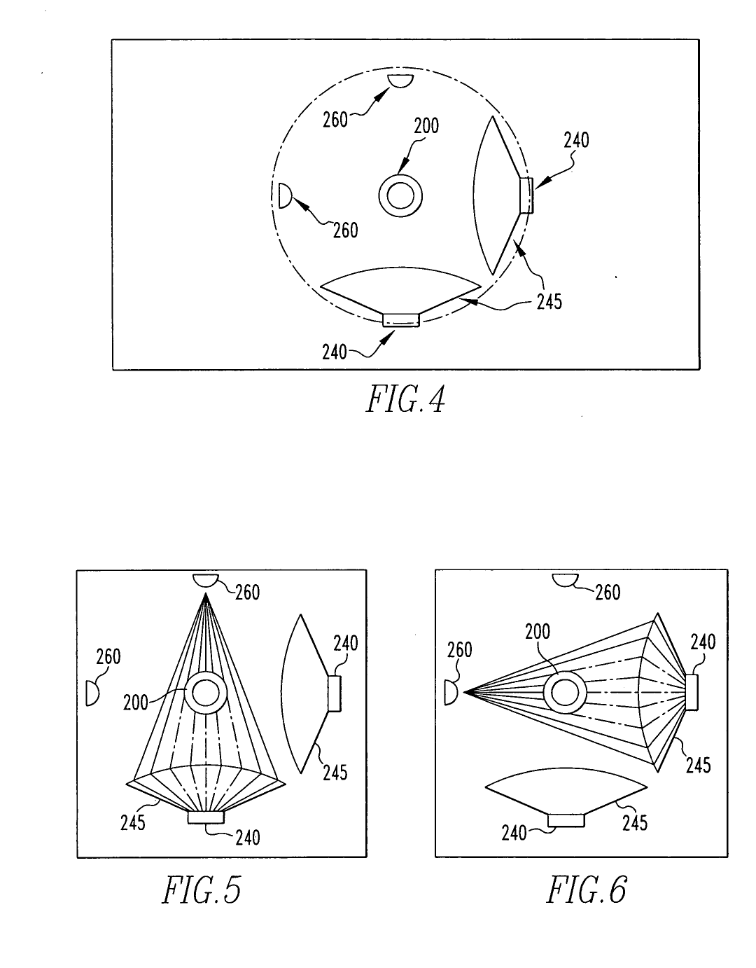

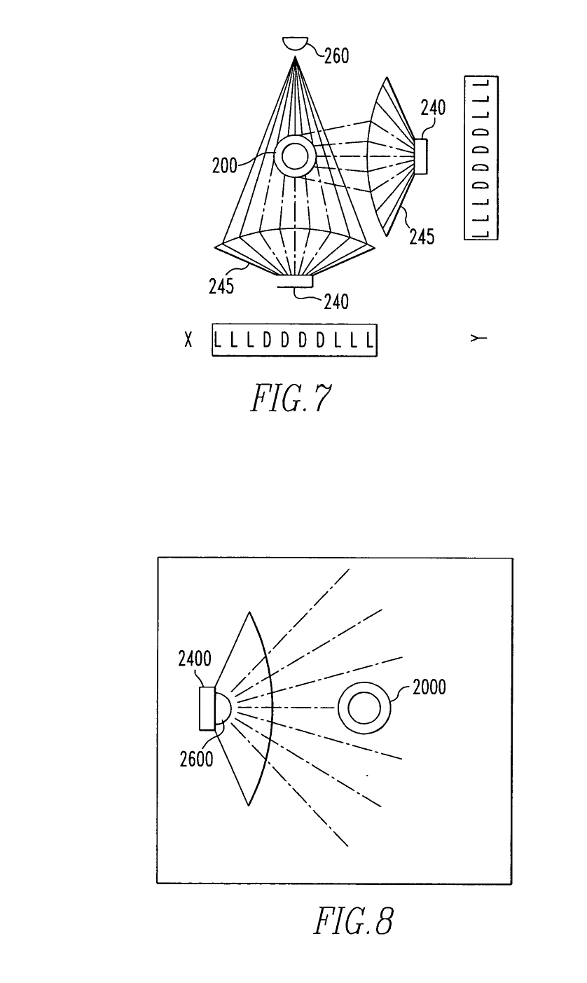

FIGS. 4-6 show, in schematic form, a simplified array in which light-emitting diodes (LEDs) 260 are positioned opposite the elongate shaft 200 from light sensors 240 having lenses 245 associated therewith. The lenses 245 are provided to match optically the detection window with the shaft movement “footprint” of the joystick. To eliminate possible interference from the LED into the sensor and vice versa, the sampling from the light sensors 240 is preferably multiplexed, meaning that the light sensors are used to take separate readings individually over time. FIGS. 5 and 6 show how the readings are serially measured. FIG. 7 shows the results of the multiplexed detection in an array in which the horizontal sensor is “x” and the vertical sensor is “y,” and the L data indicate “bright pixels” whereas the D data indicate “dark pixels.” FIG. 8 illustrates another arrangement in which the light source 2600 and the light sensor 2400 are mounted in very close proximity to one another, so that any light which hits the shaft 2000 is reflected back to the light sensor 2400 and any light which does not strike the shaft 2000 is deflected and thus dissipated.

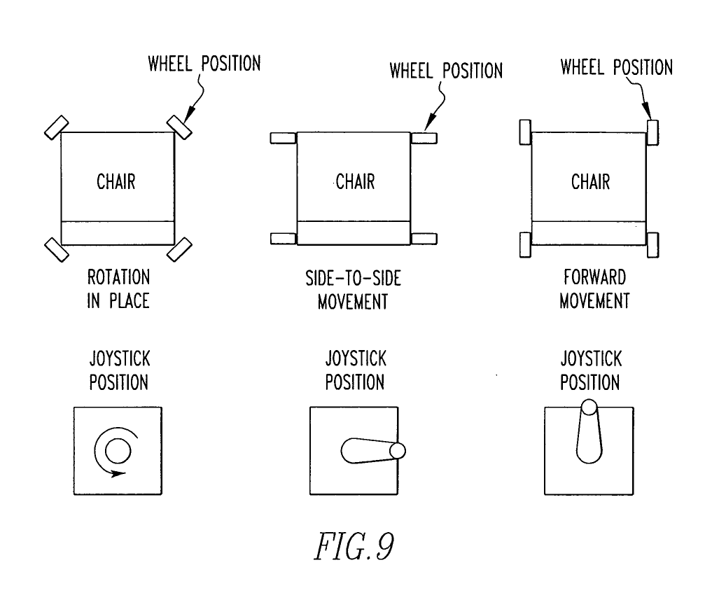

FIG. 9 illustrates in schematic form the wheel positions of the four wheels of a wheelchair in three exemplary joystick orientations.

The invention in its broadest sense is an array wherein at least two light sensors disposed generally rectilinearly create a motion-sensing grid within which the relative motion and/or rotation of any construct which “breaks the plane” of the grid can be registered by the sensors and processed accordingly. Such a motion-sensing grid might substitute for a computer mouse, in which a computer user's finger would substitute for the elongate shaft described above, or a motion-sensing grid might form a part of a heads-up display in a vehicle. In the heads up display application, as in the “grid” mouse application, a human finger or substitute pointer tool such as a stylus would substitute for the elongate shaft as described above, but in every other way the two sensors would detect and report the position and change of position of the finger or tool providing the control direction. It should be noted that in a particular variant of the present invention, it is not strictly necessary to have two light sensors and a single light sensor can suffice. If a joystick shaft is positioned adjacent a single light sensor, the joystick translation in a single dimension parallel to the light sensor, plus the joystick rotation if any, can both be sensed by the light sensor. In such case the joystick will govern operation in only a single direction, presumably forward and backward, as well as rotational operation. While true sideways motion is not possible with the single light sensor embodiment (unless the joystick were oriented to allow side-to-side motion rather than forward/backward motion), other advantages of the invention still apply, such as unwanted wear at contact surfaces and/or avoidance of magnetic interference.

The invention claimed is:

1. A joystick having a housing and a handle having a shaft thereon, wherein the shaft is positioned adjacent at least two light sensors positioned to create a two-dimensional plane and which two-dimensional plane is intersected by said shaft, whereby both angular and rotational motion of the shaft are discernable by the light sensors when a light source is directed towards said shaft.

2. The joystick according to claim 1 wherein said shaft has an optically variant stripe thereon.

3. The joystick according to claim 1 wherein said shaft has an optically variant texture or pattern thereon.

4. The joystick according to claim 1 wherein said shaft has an optically variant groove or carving therein.

5. The joystick according to claim 1 wherein each light sensor has a lens associated therewith.

6. The joystick according to claim 1 wherein the light sensor is a CCD.

7. The joystick according to claim 1 wherein the light sensor is a CMOS.

8. A joystick having a house and a handle having a shaft thereon, wherein the shaft is positioned adjacent at least one light sensor whereby both parallel and rotational motion of the shaft are discernable by said light sensor when a light is shone on the shaft.
